(19) United States
(12) Patent Application Publication
(10) Pub. No.: US 2012/0108745 A1
(43) Pub. Date: May 3, 2012

(54) METHOD FOR PRODUCING TANTALUM OXIDE PARTICLES

(75) Inventor: Tetsushi Yamamoto, Tokyo (JP)

(73) Assignee: CANON KABUSHIKI KAISHA, Tokyo (JP)

(21) Appl. No.: 13/282,845

(22) Filed: Oct. 27, 2011

(30) Foreign Application Priority Data
Nov. 1, 2010 (JP) 2010-245488

(51) Int. Cl. G02B 1/04; C08K 3/22; C01G 35/00

(52) U.S. Cl. 524/780; 423/594.17

(57) ABSTRACT

A method for producing a tantalum oxide particle including preparing tantalum alkoxide in a container and hydrolyzing the tantalum alkoxide in the container, wherein a maximum temperature T (° C.) in the container and a maximum pressure P (MPa) in the container in the hydrolysis satisfy the following formulae (1) and (2):

205≦T<300 (1), and

P≧0.9 (2).

### BACKGROUND OF THE INVENTION

1. Field of the Invention

The present invention relates to a method for producing tantalum oxide particles.

2. Description of the Related Art

A tantalum oxide particle is difficult to absorb light in a visible region, has a high refractive index and a low Abbe's number, and thus is used as an additive for lenses.

In particular, variations in refractive index and Abbe's number in the particles are smaller in crystallized tantalum oxide particles than in amorphous tantalum oxide particles. Thus, when the crystallized tantalum oxide particle is used for a base material for the lens, the variations in refractive index and Abbe's number in positions in the lens are also small.

The crystallized tantalum oxide particle is conventionally obtained by placing tantalum pentabutoxide dissolved in an organic solvent such as toluene in an autoclave container and hydrolyzing tantalum pentabutoxide at 300° C. under high pressure (H. Kominami et al., Physical Chemistry Chemical Physics, No. 3, Vol. 13, pages 2697-2703, 2001, hereinafter referred to as Non-patent Literature 1). In general, it is known that the particles are likely aggregated one another because the particles highly frequently conflict one another when the reaction is performed at high temperature of 300° C. or above in producing inorganic particles. Meanwhile, it is conventionally known that the amorphous tantalum oxide particle is obtained when tantalum alkoxide is hydrolyzed at low temperature under low pressure.

### SUMMARY OF THE INVENTION

Thus, aspects of the present invention provide a method for producing a crystallized tantalum oxide particle at temperature lower than 300° C.

The method for producing the tantalum oxide particle by preparing tantalum alkoxide and hydrolyzing the tantalum alkoxide in the container according to aspects of the present invention is characterized in that a maximum temperature T (° C.) in a container and a maximum pressure (P) (MPa) in the container in a hydrolysis satisfy the following formulae (1) and (2):

205≦T<300 (1), and

P≧0.9 (2)

According to aspects of the present invention, the crystallized tantalum oxide particle can be produced even at low temperature by hydrolyzing tantalum alkoxide under the high pressure.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are views for illustrating the method for producing tantalum oxide particles according to embodiments of the present invention.

FIG. 2 is a view for illustrating one example of a method for producing an optical element according to embodiments of the present invention.

FIG. 3 is a graph showing results obtained in Examples and Comparative Examples in the present invention.

### DESCRIPTION OF THE EMBODIMENTS

Various exemplary embodiments, features, and aspects of the invention will be described in detail below with reference to the drawings.

The method for producing the tantalum oxide particle includes preparing tantalum alkoxide in the container and hydrolyzing the tantalum alkoxide in the container. The method for producing the tantalum oxide particle according to the present embodiment is characterized in that a maximum temperature T (° C.) in a container and a maximum pressure (P) (MPa) in the container in a hydrolysis satisfy the following formulae (1) and (2):

205≦T<300 (1), and

P≧0.9 (2)

Here, when tantalum penta-normal-butoxide (Ta(OC₄H₉)₅) is used as tantalum alkoxide, a hydrolysis reaction represented by the following formulae (i) and (ii) occurs.

Ta(OC₄H₉)₅+5H₂O→Ta(OH)₅+5C₄H₉OH (i), and

2Ta(OH)₅→Ta₂O₅+5H₂O (ii)

T and P below mean the maximum temperature T (° C.) and the maximum pressure (P) (MPa) in the container in the hydrolysis same as the above. A percentage of a time period at the maximum temperature T (° C.) during a time period of the hydrolysis reaction in the hydrolysis in the present embodiment may be 50% or more, such as 75% or more and even such as 100% or more. A percentage of a time period at the maximum pressure P (MPa) during a time period of the hydrolysis reaction in the hydrolysis in the present embodiment may be 50% or more, such as 75% or more and even 100% or more.

In the hydrolysis, it may be the case that that the tantalum alkoxide is reacted with water at the maximum temperature T (° C.) in the container. When tantalum alkoxide is caused to react with water at the maximum temperature T (° C.), a reaction rate is fast. The crystallized tantalum oxide particle can be obtained by performing this hydrolysis reaction under the condition of the above formulae (1) and (2). Further, the hydrolysis reaction is performed at temperature lower than 300° C. Thus, the tantalum oxide particles are difficult to aggregate one another, and the crystallized tantalum oxide particle having a small particle diameter can be obtained. When the particle having the small particle diameter is added to the base material for the lens, the resulting lens is hard to scatter the light. Meanwhile, when the hydrolysis reaction is performed at temperature of 300° C. or above, the tantalum oxide particles highly frequently conflict one another, and thus, the tantalum oxide particles are likely to aggregate one another. It may also be the case that the hydrolysis reaction satisfies the above formula (1), and the following formulae (3), (4) and (5):

P≧−0.89T+189.56 (205≦T<210) (3),

P≧−0.043T+11.69 (210≦T<250) (4), and

P≧0.9 (250≦T<300) (5).

Further, it may be the case that the hydrolysis reaction satisfies the above formulae (3) and (4) and the following formulae (6) and (7):

P≦−0.024T+12.03 (205≦T≦250) (6), and

205≦T<250 (7).

Also it may be the case that the hydrolysis reaction satisfies the following formula (8):

P≦10 (8)

By setting the maximum pressure in the container to 10 MPa or less, it is possible to reduce cost for equipments such as the container and a pressurizing mechanism used for performing the hydrolysis reaction.

It is believed that the hydrolysis reaction of tantalum alkoxide other than tantalum penta-normal-butoxide also satisfies the above formulae (i) and (ii) and the crystallized tantalum oxide particle is finally obtained.

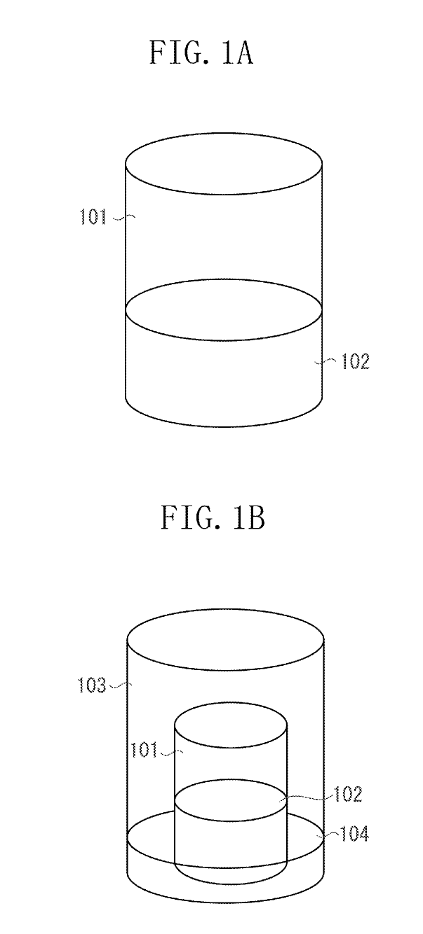

The method for producing the tantalum oxide particle according to a first embodiment of the present invention will be described using FIG. 1A.

First, a mixture of tantalum alkoxide and an organic solvent 102 is prepared in a first vessel 101 that is a reaction container.

Subsequently, water is added to the mixture of the organic solvent and tantalum oxide. At that time, an internal environment of the first vessel is adjusted so that the maximum temperature T (° C.) and the maximum pressure P (MPa) inside the first vessel satisfy the above formulae (1) and (2). By adjusting in this way, it is possible to obtain the crystallized tantalum oxide particle.

The method for producing the tantalum oxide particle according to the present embodiment may comprise a step(s) other than the above steps. For example, a step of adding a surface modifier to a surface of the resulting crystallized tantalum oxide particle is included. By adding the surface modifier, it is possible to further inhibit the aggregation of the tantalum oxide particles with one another.

In the present embodiment, the first vessel that is the reaction container is not particularly limited in shape as long as it is heat resistant, pressure resistant and sealed tightly, and for example, an autoclave can be used. It may be the case that the autoclave made of stainless used steel (hereinafter sometimes abbreviated as SUS) is used as the first vessel because this is highly resistant to both the heat and the pressure.

The first vessel may be of a batch type or a flow type.

A means to elevate the temperature or pressurize inside the autoclave in order to adjust the environment inside the autoclave is not limited particularly. For example, first the temperature inside the autoclave is elevated to the reaction temperature by heating from an outside of the autoclave using an electric furnace. And, the pressure inside of the autoclave can be elevated by introducing an inert gas from the outside of the autoclave to the inside of the autoclave when the temperature inside the autoclave reaches the reaction temperature. If the pressure inside the autoclave has already reached the required pressure when the temperature inside the autoclave reaches the reaction temperature, it is unnecessary to introduce the inert gas from the outside of the autoclave to the inside of the autoclave.

Also, the temperature may be elevated to the reaction temperature after elevating the pressure inside the autoclave to the required pressure.

The above inert gas includes nitrogen gas, helium gas, neon gas, and argon gas.

The above reaction temperature and required pressure are values within the ranges represented by the above formulae (1) and (2).

A reaction time may be 1 hour or more and 10 hours or less, and such as 2 hours or more and 7 hours or less in order to smoothly produce crystallized tantalum oxide through the hydrolysis reaction of tantalum alkoxide with water, a condensation polymerization reaction, and a phase transition reaction from an amorphous form.

Tantalum alkoxide in the present embodiment includes tantalum pentamethoxide, tantalum pentaethoxide, tantalum penta-normal-propoxide, tantalum penta-iso-propoxide, tantalum penta-normal-butoxide, tantalum penta-iso-butoxide, tantalum penta-secondary-butoxide, tantalum penta-tertiary-butoxide, tantalum tertiary-pentyl oxide, tantalum tertiary-hexyl oxide, and tantalum tertiary-heptyl oxide.

The organic solvent in the present embodiment includes hydrocarbon, ethers, alcohols, and ionic liquids.

Hydrocarbon includes benzene, toluene, xylene, cyclohexane, methylcyclohexane, pentane, hexane, iso-hexane, heptane, octane, nonane, and 1-octadecene.

Ethers include diethyl ether and tetrahydrofuran.

Alcohols include methanol, ethanol, propanol, isopropanol, butanol, isobutanol, secondary-butanol, tertiary-butanol, pentanol, 2-pentanol, iso-pentanol, tertiary-pentanol, hexanol, 2-methyl-2-pentanol, 3-methyl-3-pentanol, heptanol, benzyl alcohol, 1,2-ethanediol, 1,3-butanediol, 1,4-propanediol, 1,5-pentanediol, 1,6-hexanediol, diethylene glycol, triethylene glycol, tetraethylene glycol, polyethylene glycol, and glycerin.

The ionic liquids include a 1-ethyl-3-methyl imidazolium salt, a 1-butyl-3-methyl imidazolium salt, a 1-hexyl-3-methyl imidazolium salt, a 1-octyl-3-methyl imidazolium salt, a 1-hexadecyl-3-methyl imidazolium salt, 1-octadecyl-3-methyl imidazolium salt, a 1-ethyl-2,3-dimethyl imidazolium salt, a 1-butyl-2,3-dimethyl imidazolium salt, a 1-hexyl-dimethyl imidazolium salt, a 1-ethyl pyridinium salt, a 1-butyl pyridinium salt, a 1-hexyl pyridinium salt, a 1-methyl-3-allyl imidazolium salt, a 1-ethyl-3-allyl imidazolium salt, a 1-butyl-3-allyl imidazolium salt, a 1-pentyl-3-allyl imidazolium salt, a 1-octyl-3-allyl imidazolium salt, a 1-allyl-3-etyhl imidazolium salt, a 1-allyl-3-butyl imidazolium salt, a 1,3-diallyl imidazolium salt, a 1-ethyl-2,3,5-trimethyl pyrazolium salt, a 1-propyl-2,3,5-trimethyl pyrazolium salt, and a 1-butyl2,3,5-trimethyl pyrazolium salt.

The surface modifier in the present embodiment includes silane-based coupling agents, organic carboxylic acids, organic nitrogen compounds, organic sulfur compounds, and organic phosphorous compounds.

The silane-based coupling agent includes methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, propyltrimethoxysilane, propyltriethoxysilane, hexyltrimethoxysilane, hexyltriethoxysilane, decyltrimethoxysilane, trifluoropropyltrimethoxysilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-stylyltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, and 3-isocyanate propyltriethoxysilane.

The organic carboxylic acids include a hexylic acid, an octylic acid, a decylic acid, a dodecylic acid, a tetradecylic acid, a hexadecylic acid, an octadecylic acid, an oleic acid, an elaidic acid, an erucic acid, a nervonic acid, a linoleic acid, a γ-linolenic acid, a di-homo-γ-linolenic acid, an arachidonic acid, an α-linolenic acid, a stearidonic acid, an eicosapentaenoic acid, a docosahexaenoic acid, a cyclohexanecarboxylic acid, a maleic acid and a fumaric acid.

The organic nitrogen compound includes hexylamine, octylamine, decylamine, dodecylamine, tetradecylamine, hexadecylamine, octadecylamine, phenylamine, dihexylamine, dioctylamine, didecylamine, didodecylamine, ditetradecylamine, dihexadecylamine, dioctadecylamine, diphenylamine, trihexylamine, trioctylamine, tridecylamine, tridodecylamine, tritetradecylamine, trihexadecylamine, trioctadecylamine, triphenylamine, and oleylamine.

The organic sulfur compound includes an octylbenzenesulfonic acid, a decylbenzenesulfonic acid, a dodecylbenzenesulfonic acid, a tetradecylbenzenesulfonic acid, a hexadecylbenzenesulfonic acid, an octadecylbenzenesulfonic acid, hexanethiol, octanethiol, decanethiol, dodecanethiol, tetradecanethiol, hexadecanethiol, and octadecanethiol.

The organic phosphorous compound includes a hexylphosphonic acid, an octylphosphonic acid, a decylphosphonic acid, a dodecylphosphonic acid, a tetradecylphosphonic acid, a hexadecylphosphonic acid, an octadecylphosphonic acid, a phenylphosphonic acid, trihexylphosphine, trioctylphosphine, tridecylphosphine, tridodecylphosphine, tritetradecylphosphine, trihexadecylphosphine, trioctadecylphosphine, triphenylphosphine, trihexylphosphine oxide, trioctylphosphine oxide, tridecylphosphine oxide, tridodecylphosphine oxide, tritetradecylphosphine oxide, trihexadecylphosphine oxide, trioctadecylphosphine oxide, triphenylphosphine oxide, tris(2-ethylhexyl)phosphate, and triphenyl phosphate. The above surface modifier may be used alone or in mixture of two or more.

According to the method for producing the tantalum oxide particle according to the present embodiment, the tantalum oxide particle crystallized in a δ (delta) phase is obtained as described later in Examples. The tantalum oxide particle in the δ phase among the crystallized tantalum oxide particles has a spherical shape more frequently than those in an α (alpha) phase and a β (beta) phase. Thus, when the tantalum oxide particle in the δ phase is added to an organic polymer or glass to form a composite material, the composite material is particularly suitable for the additive for the lens because the composite material is hard to cause scatter and refraction.

It is possible to prepare a dispersion in which an organic monomer and the tantalum oxide particles obtained by the method for producing the tantalum oxide particle according to the present embodiment have been dispersed in a polar solvent or a nonpolar solvent using a wet medium stirring mill (bead mill).

Thermoplastic resins such as Polyethylene (PE), polypropylene (PP), polystyrene (PS), polyvinyl acetate, Teflon (registered trade name), ABS resins, AS resins, acryl resins (PMMA), polyamide, polyacetal, polycarbonate (PC), polyethylene terephthalate (PET), cyclic polyolefin (COP) and polyimide (PI), and thermosetting resins such as phenol resins, epoxy resins and polyimide (PI) can be used as the above organic monomer. In particular, it may be that a hydrocarbon-based monomer and an alicyclic monomer are used as the organic monomer because a hygroscopic property and a line swelling property are low.

A transparent organic polymer/inorganic particle composite material can be obtained by irradiating or treating the above dispersion of the organic monomer and the tantalum oxide particles with the light or the heat to polymerize and cure the organic monomer. The optical lens having the high refractive index, high dispersion (low Abbe's number) and high transparency can be obtained by molding or processing the composite material when polymerized and cured or after being polymerized and cured.

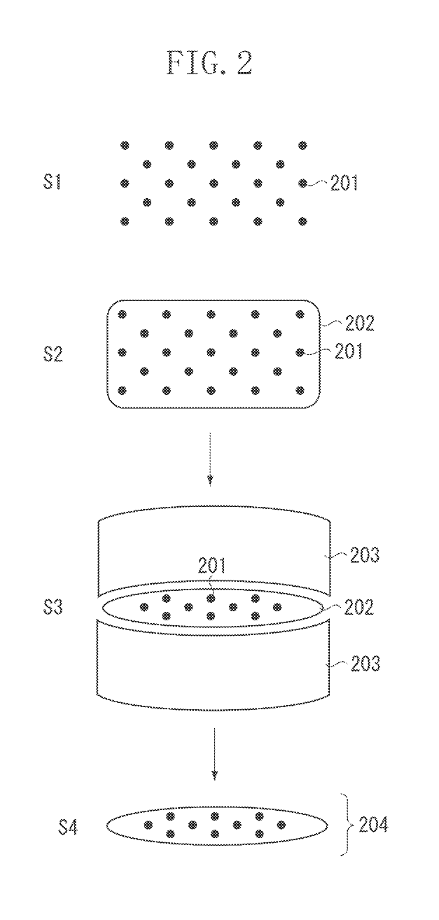

One example of the method for producing the optical element according to the present embodiment will be described using FIG. 2. First, the tantalum oxide particles 201 obtained by the above method for producing the tantalum oxide particles are prepared (S1). Subsequently, the prepared tantalum oxide particles 201 are dispersed in an organic monomer 202 (S2). Subsequently, the organic monomer in which the tantalum oxide particles have been dispersed is placed in a mold 203 (S3). And the organic monomer is cured (S4). By passing these steps, it is possible to obtain the optical element 204.

Here, the optical element such as a convex lens is shown in FIG. 2, but by appropriately selecting the mold, it is also possible to make the optical element such as a concave lens, and a cylindrical lens.

The above method of dispersing the tantalum oxide particles in the organic monomer includes methods using a beer mill, a bead mill, a jet mill and a kneader. A procedure of curing the organic monomer includes a method of curing with heat, a method of curing with ultraviolet light, a method of curing in combination of the ultraviolet and visible light, a method of curing by irradiating with microwave or milliwave, and a method of curing by irradiating with EB.

It is also possible to use the thermosetting resin or the thermoplastic resin in place of the above organic monomer. To cure the thermoplastic resin, the thermoplastic resin can be cooled.

The optical element may be molded into a desired shape using the mold, but the desired shape may be molded by polishing and processing after curing the organic monomer in which the tantalum oxide particles have been dispersed.

Another example of the method for producing the optical element according to the present embodiment is a method of obtaining the optical element by mixing the organic solvent in which the tantalum oxide particles have been dispersed with the organic monomer, subsequently removing the organic solvent, and then curing the organic monomer.

Examples of the optical element obtained by the method for producing the optical element according to the present embodiment include camera lenses for shooting; lenses for microscopes, endoscopes and telescopes; all light ray transmittance lenses such as glass lenses as optical lenses and optical prisms; pickup lenses for optical disks such as CD, CD-ROM, WORM (write once read many, recordable optical disks), MO (rewritable optical disks; magnetic optical disks), MD (minidisks), DVD (digital video disks) as the use for the optical disks; laser scanning lenses such as fe lenses of laser beam printers and lenses for sensors as scanning optical lenses; and prism lenses for camera finder systems. Other examples include light guide plates for liquid crystal displays; optical films such as polarizing films, phase contrast films and light diffusion films; light diffusion plates; light cards; and liquid crystal display device boards.

It may be the case that the above optical element is the lens. When the lens is produced, the method may further have a step of providing an antireflection film on the surface of the optical element and may further have a step of providing an intermediate layer between the antireflection film and the optical element after the step of obtaining the optical element above. The antireflection film is not particularly limited, and may have the refractive index close to the refractive index of the lens. The intermediate layer is not particularly limited, and may be composed of a material having an intermediate values between the refractive index of the lens and the refractive index of the antireflection film. In the lens, a film that is substantially opaque in a wavelength region to be used may be formed in a portion through which the light cannot pass, typically a side edge portion of the lens (common name is an edge portion), in order to reduce an internal reflection.

Further, the tantalum oxide particles obtained by the method for producing the tantalum oxide particle according to the present embodiment can be added to the glass (glass material) to use it as the optical lens. The optical lens having the high transparency can be obtained by processing the tantalum oxide particles using a hot isostatic press (HIP) method, a spark plasma sintering (SPS) method, a vacuum sintering method, or a vacuum hot press.

Examples of the above optical lens include concave lenses, convex lenses, spherical lenses, aspherical lenses, diffraction optical elements (DOE), and gradient index lenses (GRIN).

The above optical lenses can be mounted on film cameras, digital still cameras (DSC), video cameras (VC), mobile phone cameras, security cameras, TV cameras, movie cameras, and projectors.

The method for producing the tantalum oxide particle according to a second embodiment of the present invention will be described using FIG. 1B. Here, different points from the embodiment 1 are described, and the description about common points is omitted.

First, a second vessel 103 in which water 104 has been placed, and a first vessel 101 which is present in the second vessel 103 and in which a mixture 102 of tantalum alkoxide and an organic solvent has been placed are prepared. The second vessel 103 that is the reaction container is tightly sealed.

Subsequently, the temperature and the pressure are elevated in the first vessel 101 and the second vessel 103 so that the temperature and the pressure inside the first vessel 101 and the second vessel 103 satisfy the above formulae (1) and (2). When the temperature and the pressure are elevated, the water 104 in the second vessel 103 is vaporized, and enters the mixture 102 in the second vessel 103. Then, the mixture 102 and the water 104 react with each other (hydrolysis reaction).

The temperature and the pressure satisfy the condition of the above formulae (1) and (2), and thus, the reaction shown in the above formulae (i) and (ii) performs processing for producing the crystallized tantalum oxide particle.

The second vessel in the present embodiment is not particularly limited in shape as long as the vessel has the heat resistance and the pressure resistance and is not sealed tightly. It may be the case that a beaker made of SUS is used as the second vessel because both the heat resistance and the pressure resistance are high.

Examples of the present invention will be described below, but the present invention is not limited thereto.

In Examples of the present invention described below, crystallinity of the produced crystallized tantalum oxide particle was analyzed by measuring powder X-ray diffraction (XRD). RINT 2100 (X-ray tube voltage 40 kV, X-ray tube current 40 mA) manufactured by Rigaku Corporation was used as an X-ray diffraction apparatus. Here, a diffraction peak at 2θ=22.9° is derived from a (001) surface of the tantalum oxide in the δ (delta) phase (JCPDS No. 19-1299). A crystallite size D₍₀₀₁₎ of the (001) surface of the tantalum oxide in the δ (delta) phase was calculated from the resulting X-ray diffraction peak (2θ=22.9°) using the following Scherrer's formula (7). It can be said that the larger a diffraction intensity of the diffraction peak at 2θ=22.9° is and the larger the crystallite size D₍₀₀₁₎ of the (001) surface is, the tantalum oxide particles in the δ (delta) phase having the better crystallinity are produced. It can also be said that the smaller the diffraction intensity of the diffraction peak at 2θ=22.9° is and the smaller the crystallite size D₍₀₀₁₎

of the (001) surface is, the finer crystalline tantalum oxide particles are produced. Integrated analysis software for powder X-ray diffraction patterns, JADE, was used for data processing of the X-ray diffraction and the calculation of the crystallite size D₍₀₀₁₎.

D₍₀₀₁₎=K×λ_{cu-kα1}/β₍₀₀₁₎ cos θ (here, K=0.9, λ_{cu-kα1}=0.154056 (7)

nm, β₍₀₀₁₎ is a half-value width of the diffraction peak at 2θ=22.9°).

### EXAMPLE 1

27.325 g (50 mmol) of tantalum penta-normal-butoxide and 300 mL of toluene were added into an autoclave made of SUS with an internal capacity of 1 L. A lid was put on the autoclave to seal an inside, and air inside the autoclave was replaced with nitrogen gas. By heating using an electric furnace from an outside of the autoclave, the temperature inside the autoclave was elevated up to 205° C. at a temperature rising rate of 6.2° C./minute. The pressure inside the autoclave was 0.62 MPa when the temperature inside the autoclave reached 205° C. Subsequently, the nitrogen gas was introduced into the autoclave to increase the pressure inside the autoclave to 5.90 MPa. Subsequently, 45 g (2.5 mol) of water was added into the autoclave using a single plunger pump. At that time, the pressure inside the autoclave was 6.41 MPa. The temperature inside the autoclave was kept at 205° C., and the reaction occurred while stirring for 6 hours. The maximum pressure at that time was 7.11 MPa. After cooling, a resulting precipitate was filtered and separated, and dried under reduced pressure to yield 11.74 g of white powder. This white powder was used as a sample to be measured, and its XRD was measured. The obtained white powder was found to be crystallized tantalum oxide in the δ (delta) phase from its X-ray diffraction pattern (JCPDS No. 19-1299). A diffraction peak derived from a (001) surface was observed around at 2θ=22.9°. Its maximum diffraction intensity was 1406 cps, and a crystallite size of the (001) surface was found to be 12 nm from Scherrer's formula.

### EXAMPLE 2

27.325 g (50 mmol) of tantalum penta-normal-butoxide and 300 mL of toluene were added into the autoclave made of SUS with the internal capacity of 1 L. The lid was put on the autoclave to seal the inside, and the air inside the autoclave was replaced with the nitrogen gas. By heating using the electric furnace from the outside of the autoclave, the temperature inside the autoclave was elevated up to 210° C. at a temperature rising rate of 5.0° C./minute. The pressure inside the autoclave was 0.76 MPa when the temperature inside the autoclave reached 210° C. Subsequently, 45 g (2.5 mol) of water was added into the autoclave using the single plunger pump. At that time, the pressure inside the autoclave was 2.59 MPa. The temperature inside the autoclave was kept at 210° C., and the reaction occurred while stirring for 6 hours. The maximum pressure at that time was 2.66 MPa. After cooling, a resulting precipitate was filtered and separated, and dried under reduced pressure to yield 12.77 g of white powder. This white powder was used as the sample to be measured, and its XRD was measured. The obtained white powder was found to be crystallized tantalum oxide in the δ (delta) phase from the X-ray diffraction pattern (JCPDS No. 19-1299). A diffraction peak derived from the (001) surface was observed around at 2θ=22.9°. Its maximum diffraction intensity was 1670 cps, and the crystallite size of the (001) surface was found to be 18 nm from Scherrer's formula.

### EXAMPLE 3

27.325 g (50 mmol) of tantalum penta-normal-butoxide and 300 mL of toluene were added into the autoclave made of SUS with the internal capacity of 1 L. The lid was put on the autoclave to seal the inside, and the air inside the autoclave was replaced with the nitrogen gas. By heating using the electric furnace from the outside of the autoclave, the temperature inside the autoclave was elevated up to 220° C. at a temperature rising rate of 5.4° C./minute. The pressure inside the autoclave was 0.83 MPa when the temperature inside the autoclave reached 220° C. Subsequently, 45 g (2.5 mol) of water was added into the autoclave using the single plunger pump. At that time, the pressure inside the autoclave was 3.07 MPa. The temperature inside the autoclave was kept at 220° C., and the reaction occurred while stirring for 6 hours. The maximum pressure at that time was 3.21 MPa. After cooling, a resulting precipitate was filtered and separated, and dried under reduced pressure to yield 11.39 g of white powder. This white powder was used as the sample to be measured, and its XRD was measured. The obtained white powder was found to be crystallized tantalum oxide in the δ (delta) phase from the X-ray diffraction pattern (JCPDS No. 19-1299). A diffraction peak derived from the (001) surface was observed around at 2θ=22.9°. Its maximum diffraction intensity was 4050 cps, and the crystallite size of the (001) surface was found to be 37 nm from Scherrer's formula.

### EXAMPLE 4

5.465 g (10 mmol) of tantalum penta-normal-butoxide and 100 mL of cyclohexane were added into the autoclave made of SUS with the internal capacity of 1 L. The lid was put on the autoclave to seal the inside, and the air inside the autoclave was replaced with the nitrogen gas. By heating using the electric furnace from the outside of the autoclave, the temperature inside the autoclave was elevated up to 250° C. at a temperature rising rate of 5.6° C./minute. The pressure inside the autoclave was 2.31 MPa when the temperature inside the autoclave reached 250° C. Subsequently, 27 g (1.5 mol) of water was added into the autoclave using the single plunger pump. At that time, the pressure inside the autoclave was 3.21 MPa. The temperature inside the autoclave was kept at 250° C., and the reaction occurred while stirring for 6 hours. The maximum pressure at that time was 6.03 MPa. After cooling, a resulting precipitate was filtered and separated, and dried under reduced pressure to yield 2.22 g of white powder. This white powder was used as the sample to be measured, and its XRD was measured. The obtained white powder was found to be crystallized tantalum oxide in the δ (delta) phase from the X-ray diffraction pattern (JCPDS No. 19-1299). A diffraction peak derived from the (001) surface was observed around at 2θ=22.9°. Its maximum diffraction intensity was 9722 cps, and the crystallite size of the (001) surface was found to be 43 nm from Scherrer's formula.

### EXAMPLE 5

5.465 g (10 mmol) of tantalum penta-normal-butoxide and 100 mL of toluene were added into the autoclave made of SUS with the internal capacity of 1 L. The lid was put on the autoclave to seal the inside, and the air inside the autoclave was replaced with the nitrogen gas. By heating using the electric furnace from the outside of the autoclave, the temperature inside the autoclave was elevated up to 250° C. at a temperature rising rate of 2.2° C./minute. The pressure inside the autoclave was 1.54 MPa when the temperature inside the autoclave reached 250° C. Subsequently, 27 g (1.5 mol) of water was added into the autoclave using the single plunger pump. At that time, the pressure inside the autoclave was 2.76 MPa. The temperature inside the autoclave was kept at 250° C., and the reaction occurred while stirring for 6 hours. The maximum pressure at that time was 5.14 MPa. After cooling, a resulting precipitate was filtered and separated, and dried under reduced pressure to yield 1.94 g of white powder. This white powder was used as the sample to be measured, and its XRD was measured. The obtained white powder was found to be crystallized tantalum oxide in the δ (delta) phase from the X-ray diffraction pattern (JCPDS No. 19-1299). A diffraction peak derived from the (001) surface was observed around at 2θ=22.9°. Its maximum diffraction intensity was 10191 cps, and the crystallite size of the (001) surface was found to be 40 nm from Scherrer's formula.

### EXAMPLE 6

A 300 mL beaker made of SUS was placed in the autoclave made of SUS with the internal capacity of 1 L. Then, 5.465 g (10 mmol) of tantalum penta-normal-butoxide and 100 mL of methylcyclohexane were placed in the beaker made of SUS, and 27 g (1.5 mol) of water was added to a space between the beaker made of SUS and an inner wall surface of the autoclave made of SUS. The lid was put on the autoclave to seal the inside tightly, and the air inside the autoclave was replaced with argon gas. By heating using the electric furnace from the outside of the autoclave, the temperature inside the autoclave was elevated up to 250° C. at a temperature rising rate of 3.2° C./minute. The pressure inside the autoclave was 0.83 MPa when the temperature inside the autoclave reached 250° C. Subsequently, the argon gas was introduced into the autoclave to increase the pressure inside the autoclave to 0.90 MPa. The temperature inside the autoclave was kept at 250° C., and the reaction occurred while stirring for 6 hours. The maximum pressure at that time was 0.96 MPa. After cooling, a resulting precipitate was filtered and separated, and dried under reduced pressure to yield 1.85 g of white powder. This white powder was used as the sample to be measured, and its XRD was measured. The obtained white powder was found to be crystallized tantalum oxide (Ta₂O₅) in the δ (delta) phase from the X-ray diffraction pattern (JCPDS No. 19-1299). A diffraction peak derived from the (001) surface was observed around at 2θ=22.9°. Its maximum diffraction intensity was 8367 cps, and the crystallite size of the (001) surface was found to be 33 nm from Scherrer's formula.

### EXAMPLE 7

A 300 mL beaker made of SUS was placed in the autoclave made of SUS with the internal capacity of 1 L. Then, 5.465 g (10 mmol) of tantalum penta-normal-butoxide and 100 mL of cyclohexane were placed in the beaker made of SUS, and 27 g (1.5 mol) of water was added to the space between the beaker made of SUS and the inner wall surface of the autoclave made of SUS. The lid was put on the autoclave to seal the inside tightly, and the air inside the autoclave was replaced with the argon gas. By heating using the electric furnace from the outside of the autoclave, the temperature inside the autoclave was elevated up to 250° C. at a temperature rising rate of 3.5° C./minute. The pressure inside the autoclave was 0.74 MPa when the temperature inside the autoclave reached 250° C. Subsequently, the argon gas was introduced into the autoclave to increase the pressure inside the autoclave to 0.90 MPa. The temperature inside the autoclave was kept at 250° C., and the reaction occurred while stirring for 6 hours. The maximum pressure at that time was 0.94 MPa. After cooling, a resulting precipitate was filtered and separated, and dried under reduced pressure to yield 2.26 g of white powder. This white powder was used as the sample to be measured, and its XRD was measured. The obtained white powder was found to be crystallized tantalum oxide in the δ (delta) phase from the X-ray diffraction pattern (JCPDS No. 19-1299). A diffraction peak derived from the (001) surface was observed around at 28=22.9°. Its maximum diffraction intensity was 8671 cps, and the crystallite size of the (001) surface was found to be 37 nm from Scherrer's formula.

### COMPARATIVE EXAMPLE 1

A 300 mL beaker made of SUS was placed in the autoclave made of SUS with the internal capacity of 1 L. Then, 5.465 g (10 mmol) of tantalum penta-normal-butoxide and 100 mL of cyclohexane were placed in the beaker made of SUS, and 27 g (1.5 mol) of water was added to the space between the beaker made of SUS and the inner wall surface of the autoclave made of SUS. The lid was put on the autoclave to seal the inside tightly, and the air inside the autoclave was replaced with the nitrogen gas. By heating using the electric furnace from the outside of the autoclave, the temperature inside the autoclave was elevated up to 200° C. at a temperature rising rate of 2.9° C./minute. The pressure inside the autoclave was 2.38 MPa when the temperature inside the autoclave reached 200° C. Subsequently, the argon gas was introduced into the autoclave to increase the pressure inside the autoclave to 8.03 MPa. The temperature inside the autoclave was kept at 200° C., and the reaction occurred while stirring for 6 hours. The maximum pressure at that time was 8.55 MPa. After cooling, a resulting precipitate was filtered and separated, and dried at 80° C. under reduced pressure for 12 hours to yield 2.15 g of white powder. This white powder was used as the sample to be measured, and its XRD was measured. The X-ray diffraction pattern of the obtained white powder showed a halo peak (peak derived from an amorphous one), and no diffraction peak derived from crystallized tantalum oxide in the δ (delta) phase was observed. In other words, the obtained tantalum oxide was found to be amorphous.

### COMPARATIVE EXAMPLE 2

A 300 mL beaker made of SUS was placed in the autoclave made of SUS with the internal capacity of 1 L. Then, 5.465 g (10 mmol) of tantalum penta-normal-butoxide and 100 mL of toluene were placed in the beaker made of SUS, and 27 g (1.5 mol) of water was added to the space between the beaker made of SUS and the inner wall surface of the autoclave made of SUS. The lid was put on the autoclave to seal the inside tightly, and the air inside the autoclave was replaced with the argon gas. By heating using the electric furnace from the outside of the autoclave, the temperature inside the autoclave was elevated up to 250° C. at a temperature rising rate of 3.7° C./minute. The pressure inside the autoclave was 0.42 MPa when the temperature inside the autoclave reached 250° C. The temperature inside the autoclave was kept at 250° C., and the reaction occurred while stirring for 6 hours. The maximum pressure at that time was 0.44 MPa. After cooling, a resulting precipitate was filtered and separated, and dried under reduced pressure to yield 2.32 g of white powder. This white powder was used as the sample to be measured, and its XRD was measured. The X-ray diffraction pattern of the obtained white powder showed the halo peak (peak derived from the amorphous one), and no diffraction peak derived from crystallized tantalum oxide in the δ (delta) phase was observed. The obtained tantalum oxide was found to be amorphous.

### COMPARATIVE EXAMPLE 3

2.031 g (5 mmol) of tantalum penta-normal-butoxide and 100 mL of 1-octadecene were added into the autoclave made of SUS with the internal capacity of 1 L. The lid was put on the autoclave to seal the inside tightly, and the air inside the autoclave was replaced with the nitrogen gas. By heating using the electric furnace from the outside of the autoclave, the temperature inside the autoclave was elevated up to 290° C. at a temperature rising rate of 5.1° C./minute. The pressure inside the autoclave was 0.19 MPa when the temperature inside the autoclave reached 290° C. Subsequently, 3.65 g (0.2 mol) of water was added into the autoclave using a pressure resistant syringe pump. At that time, the pressure inside the autoclave was 0.36 MPa. The temperature inside the autoclave was kept at 290° C., and the reaction occurred while stirring for 6 hours. The maximum pressure at that time was 0.78 MPa. After cooling, a resulting precipitate was filtered and separated, and dried under reduced pressure to yield 1.15 g of white powder. This white powder was used as the sample to be measured, and its XRD was measured. Only the halo peak was observed in the X-ray diffraction pattern, which indicated that the white powder was amorphous tantalum oxide.

### Summary

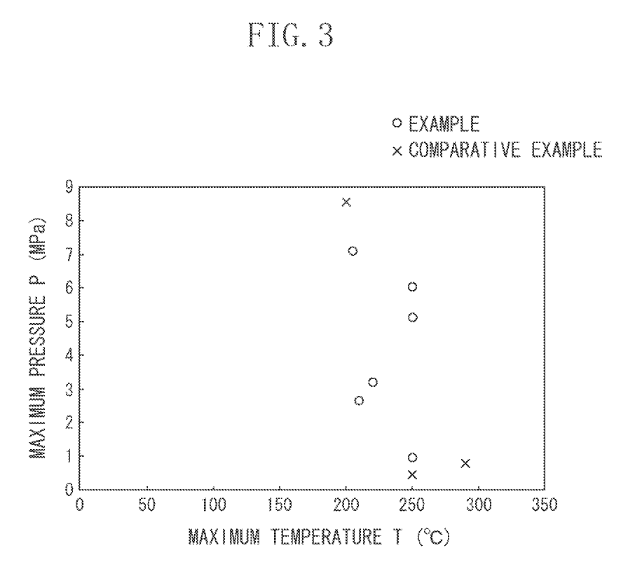

Results obtained from above Examples 1 to 7 and Comparative Examples 1 to 3 were summarized in Table 1 and FIG. 3. In Table 1 and FIG. 3, the case where the tantalum oxide particle was crystallized and the case where the tantalum oxide particle was not crystallized were represented by (Y) and (N), respectively. As described above, it has been found that the crystallized tantalum oxide particle can be produced in the case that satisfies the condition shown by the above formulae (1) and (2), such as the condition shown by the formulae (1), (3), (4) and (5), and even the case that satisfies the formulae (3), (4), (6) and (7).

TABLE 1

| | Maximum | Maximum | |
|---|---|---|---|
| | temperature | pressure | Yes or No for |
| | T(° C.) | P (MPa) | crystallization |
| Example 1 | 205 | 7.11 | Y |
| Example 2 | 210 | 2.66 | Y |
| Example 3 | 220 | 3.21 | Y |
| Example 4 | 250 | 6.03 | Y |
| Example 5 | 250 | 5.14 | Y |
| Example 6 | 250 | 0.96 | Y |
| Example 7 | 250 | 0.94 | Y |
| Comparative Example 1 | 200 | 8.55 | N |
| Comparative Example 2 | 250 | 0.44 | N |
| Comparative Example 3 | 290 | 0.78 | N |

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-245488 filed Nov. 1, 2010, which is hereby incorporated by reference herein in its entirety.

What is claimed is:

1. A method for producing a tantalum oxide particle comprising:
preparing tantalum alkoxide in a container; and
hydrolyzing the tantalum alkoxide in the container,
wherein a maximum temperature T (° C.) in the container and a maximum pressure P (MPa) in the container in the hydrolysis satisfy the following formulae (1) and (2):
205≦T<300 (1), and
P≧0.9 (2).

2. The method for producing the tantalum oxide particle according to claim 1, wherein the maximum temperature T (° C.) and a maximum pressure P (MPa) in the container in the hydrolysis satisfy the following formulae (3), (4) and (5):
P≧−0.89T+189.56 (205≦T<210) (3),
P≧−0.043T+11.69 (210≦T<250) (4), and
P≧0.9 (250≦T<300) (5).

3. The method for producing the tantalum oxide particle according to claim 1, wherein the maximum temperature T (° C.) and a maximum pressure P (MPa) in the container in the hydrolysis satisfy the following formulae (3), (4), (6) and (7):
P≧−0.89T+189.56 (205≦T<210) (3),
P≧−0.043T+11.69 (210≦T<250) (4),
P≦−0.024T+12.03 (205≦T≦250) (6), and
205≦T<250 (7).

4. The method for producing the tantalum oxide particle according to claim 1, wherein in the hydrolysis, the tantalum alkoxide reacts with water at the maximum temperature T (° C.) in the container.

5. The method for producing the tantalum oxide particle according to claim 1, wherein the tantalum oxide particle is a crystal of tantalum oxide.

6. The method for producing the tantalum oxide particle according to claim 1, wherein the tantalum alkoxide is tantalum penta-normal-butoxide.

7. A method for producing an optical element, comprising:
preparing the tantalum oxide particles according to claim 1;
dispersing the prepared tantalum oxide particles in an organic monomer; and
causing the organic monomer to cure.
